(19) United States
(12) Patent Application Publication
(10) Pub. No.: US 2005/0071613 A1
(43) Pub. Date: Mar. 31, 2005

(54) Instruction mix monitor

(76) Inventors: Chuck DeSylva, Fair Oaks, CA (US); Jesse Mitchell, Portland, OR (US); Jeffrey M. Yunes, Sharon, MA (US)

Correspondence Address: FISH & RICHARDSON, PC, 12390 EL CAMINO REAL, SAN DIEGO, CA, 92130-2081, US

(21) Appl. No.: 10/676,810

(22) Filed: Sep. 30, 2003

(51) Int. Cl. G06F 9/00

(52) U.S. Cl. 712/227

(57) ABSTRACT

Systems and techniques to monitor instruction mix in a processor. In general, in one implementation, the technique includes: identifying instruction types of sampled machine instructions being performed by a processor, and presenting a metric indicating utilization of the processor by identified instruction types. Presenting the metric may involve displaying a representation of real-time instruction mix utilization including an indication of a percent of the machine instructions that are optimized for the processor.

### BACKGROUND

The present disclosure describes systems and techniques relating to using computing systems, for example, assessing the optimization level of software with respect to a computing system.

Computing systems generally rely on processors to execute instructions provided by software. At a fundamental level, these instructions are bit patterns that command a processor to perform operations when loaded into instruction registers in the processor. The full set of instructions available for a particular processor can often be organized into different categories, or types of instructions. As new processor architectures are developed, the set of available instructions frequently increases.

Typically, new processor architectures are designed to enable legacy instruction sets to be performed on the new processor. At the same time, new instructions are introduced to handle particular types of operations more efficiently. These new instructions provide new processor features that can increase the speed of software running on the computing system when the software takes advantage of these new features. Thus, processor architectures will frequently have a set of instructions that are optimized for the architecture, and a set of instructions that are less efficient when used for certain types of operations in software. For example, optimized instructions may include multimedia instructions, where one instruction can result in multiple operations being performed by a processor using a specialized multimedia processing unit within the processor.

### DRAWING DESCRIPTIONS

FIG. 1 is a flow chart illustrating instruction mix monitoring.

FIG. 2 is a block diagram illustrating a data processing system implementing instruction mix monitoring.

FIG. 3 illustrates an example user interface for selecting instruction categories to monitor.

FIG. 4 illustrates an example display of an instruction mix property sheet in a presentation window of an instruction mix monitor.

FIG. 5 illustrates the display of the instruction mix property sheet of FIG. 4 at a later time.

FIG. 6 illustrates the display of the instruction mix property sheet of FIG. 4 with speed-step monitoring enabled.

FIG. 7 illustrates an example display of a control settings property sheet in a presentation window of an instruction mix monitor.

Details of one or more embodiments are set forth in the accompanying drawings and the description below. Other features and advantages may be apparent from the description and drawings, and from the claims.

### DETAILED DESCRIPTION

The systems and techniques described here relate to assessing the optimization level of software with respect to a computing system. An instruction mix monitor as described herein can provide a real-time view into the mix of instructions actually being retired in a processor. This can assist a software developer in optimizing software for a particular processor architecture. The systems and techniques described can provide visibility into the inner workings of a processor and facilitate taking advantage of new processor features that might otherwise be ignored or not understood.

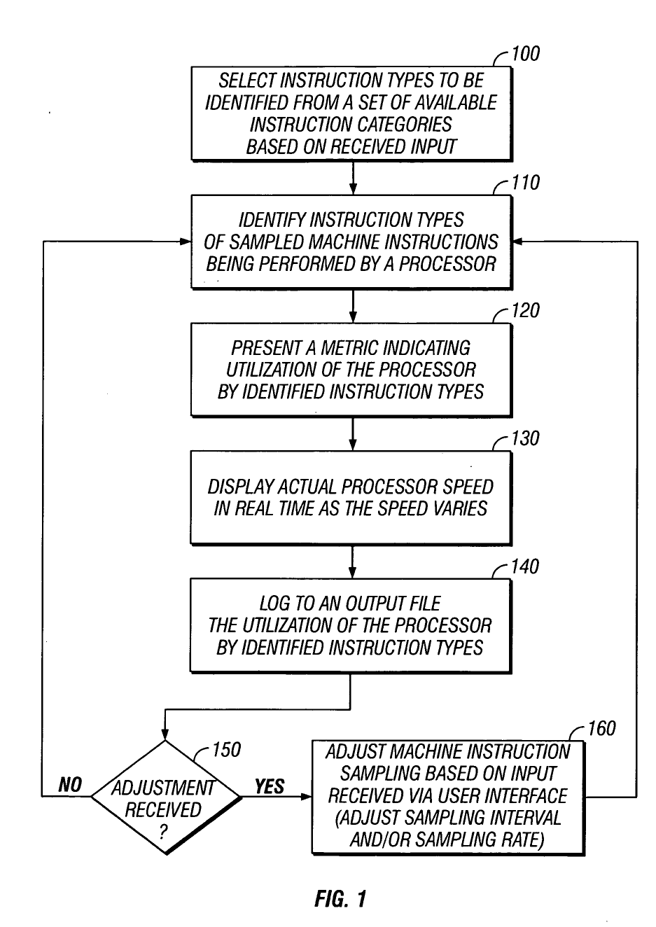

FIG. 1 is a flow chart illustrating instruction mix monitoring. Instruction types to be identified may be selected from a set of available instruction categories based on received input at 100. In general, at least two instruction categories may be provided: new instructions (more optimized) and legacy instructions (less optimized). Further breakdowns of instruction types may also be made available.

Instruction types of sampled machine instructions being performed by a processor may be identified at 110. The machine instructions may be instructions to be retired from a reorder buffer of the processor. Identifying the instruction types may involve decoding stored information (e.g., opcodes) corresponding to the machine instructions to be retired. Decoding the stored information may involve decoding instructions, including their total length, and identifying instruction types so they may be categorized, and a real-time output may be adjusted accordingly. Opcodes are numeric codes assigned to the machine instructions according to the processor architecture. These opcodes may be read from a shared memory in which the opcodes have been stored, such as described further below.

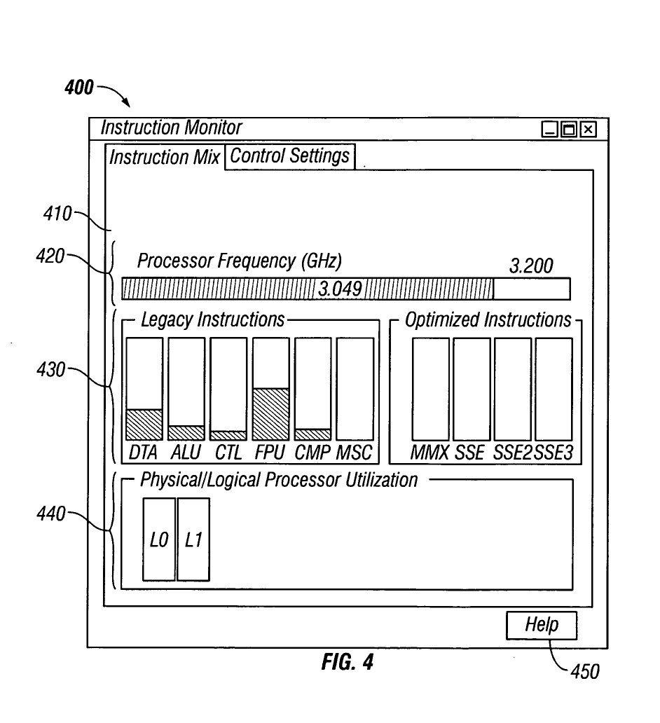

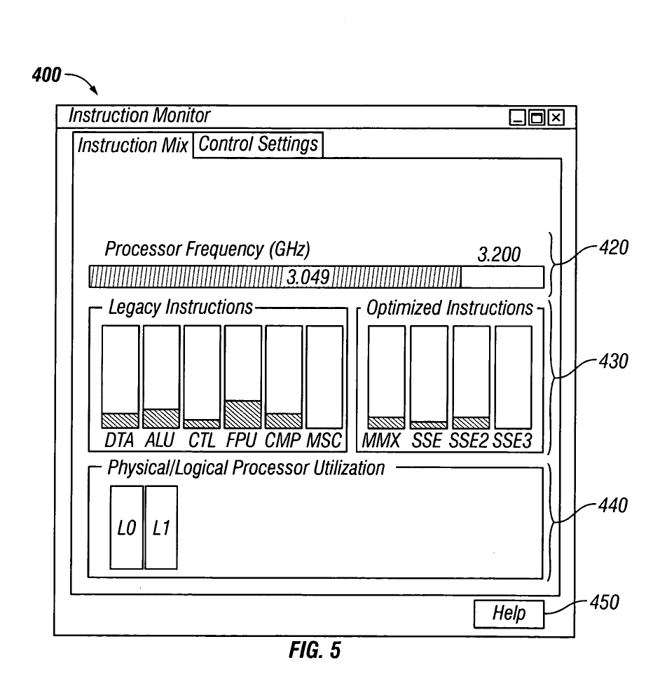

A metric indicating utilization of the processor by identified instruction types may be presented at 120. Presenting the metric indicating utilization of the processor by identified instruction types may involve displaying a representation of real-time instruction mix utilization, including an indication of a percent of the machine instructions that are optimized for the processor. Such display is discussed further below in connection with FIGS. 4-5.

Actual processor speed may be obtained and displayed in real time as the speed varies at 130. The utilization of the processor by identified instruction types may be logged to an output file (e.g., an Excel file) at 140. A user interface capable of receiving adjustments to a sampling interval and a sampling rate may be provided, and a check for a received adjustment may be made at 150. When adjustment input is received, machine instruction sampling may be adjusted based on the received input at 160. This adjustment may involve forwarding sampling adjustment information to a driver.

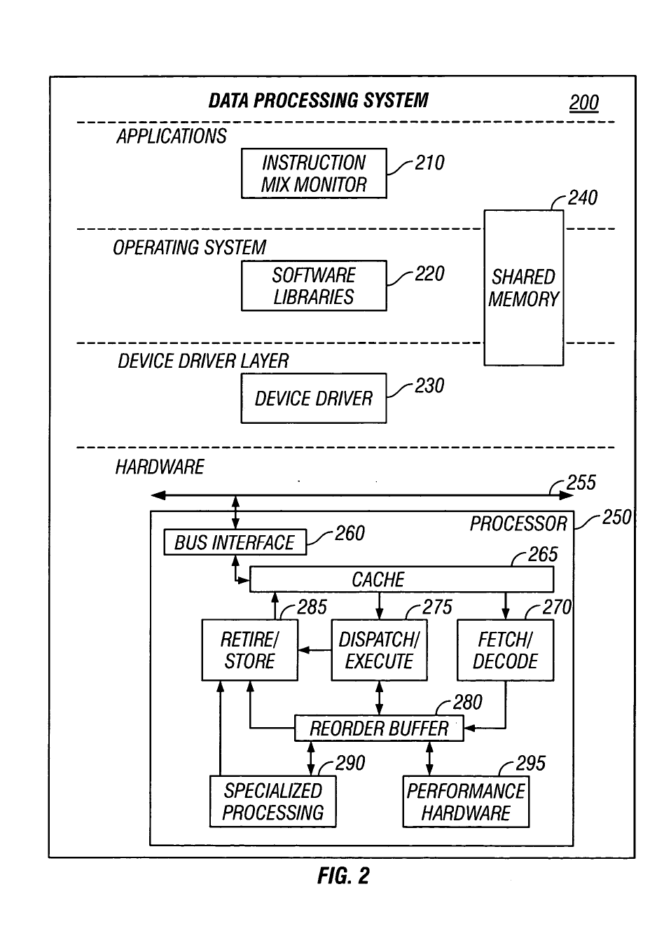

FIG. 2 is a block diagram illustrating a data processing system 200 implementing instruction mix monitoring. The system 200 may be any machine having one more processors, including a personal computer, a mobile system (e.g., a laptop, a cellular telephone or a personal digital assistant (PDA)), a minicomputer, a server, a mainframe, a supercomputer, and a special purpose programmable machine. The system 200 may include an instruction mix monitor 210 in an applications layer of the system 200. The monitor 210 may perform the operations described and may function in a user-mode of the system 200. Generally a user-mode is a designated operating space within a data processing system (e.g., Ring 3) where access to some system resources, such as a specified region of memory, is restricted.

The system 200 may include software libraries 220 in an operating system (OS), and a device driver 230 in a device driver layer of the system 200. The system 200 may include a processor 250 coupled with a system bus 255 using a bus interface 260. The processor 250 may include a cache 265, which may be divided into an instruction cache and a data cache and/or into multiple levels (e.g., a level 1 cache and a level 2 cache). The processor 250 may also include a fetch-decode unit 270, a dispatch-execute unit 275, a reorder buffer 280, and a retire-store unit 285.

Generally, one or more fetch-decode units 270 pull instructions from the cache 265 and decode these instructions before placing them in the reorder buffer 280, which manages execution and retirement of the instructions. Decoding the instructions may involve breaking up more complex instructions into smaller micro-instructions and/or translating instructions into larger macro-instructions, depending on the processor architecture. The dispatch-execute unit 275 may check instructions in the reorder buffer 280 and process those that have all the necessary information for execution.

The dispatch-execute unit 275 and/or the reorder buffer 280 may include distinct processing units for specific types of instructions, such as an arithmetic and logic unit (ALU). Additionally, one or more specialized processing units 290 may be provided to handle specific types of instructions, including new instruction types. These specialized processing units may include a floating point and math unit, a multimedia processing unit, an address processing unit, an integer processing unit, etc.

The retire-store unit 285 may inspect instructions in the reorder buffer 280. The retire-store unit 285 may remove completed instructions and store them temporarily until they are sent back to the cache 265. The retire-store unit 285 also may receive completed instructions directly from the dispatch execute unit(s) 275 and/or the specialized processing unit(s) 290.

Moreover, the processor 250 may include built-in performance hardware 295. The performance hardware 295 may include one or more registers built into the processor 250 for the purpose of monitoring performance. The performance hardware 295 may count events of interest, such as instructions retired, and may be programmable. The device driver 230 may control the performance hardware 295 and may operate in a kernel-mode. Generally a kernel-mode is a designated operating space within a data processing system (e.g., Ring 0) where full access to all system resources is provided.

The instruction mix monitor 210 may invoke the device driver 230 and analyze information (e.g., opcodes) placed in a shared memory 240 by the driver 230. The analysis of the shared memory may involve parsing through the data in the shared memory on a timed refresh interval or when triggered by the driver 230, and the analysis may involve decoding the information as described herein. The shared memory 240 may be a memory region shared between the application space and the kernel space of the system 200, and the shared memory 240 may be actual physical memory in the system 200. Thus, the shared memory 240 may be non-pageable (i.e., not virtual memory). This may assist in maintaining real-time performance. Additionally, the driver 230 may define (e.g., allocate) the shared memory 240 and may pass a reference to the memory 240 to the monitor 210.

The instruction mix monitor 210 may have a private interface with the driver 230 through the shared memory 240 to obtain the information specifying the sampled instruction flow fed to the execution units of the processor 250. The monitor 210 also may obtain additional information from the OS for display, such as processor utilization data for the one or more processors (physical and/or logical processors). When processor utilization data for multiple logical processors is obtained and displayed, Andahl's law may be used to determine proper assignment of utilization data per logical processor.

The monitor 210 illustrates the data it collects, and the monitor 210 may also interface with the user. The monitor 210 may operate as a system utility, with a corresponding icon in a control panel window for the OS. Additionally, the monitor 210 may be built into the OS of the system 200, instead of being built as a separate application, or may use the OS for portions of the monitor's functionality. For example, identifying machine instruction types may be performed in part using the software libraries 220 (e.g., one or more dynamic link libraries) provided by the OS.

The driver 230 may hook into a kernel of the system 200 and program the processor hardware to periodically identify a machine instruction to be retired and store information (e.g., an opcode) corresponding to that machine instruction to the shared memory 240. The driver 230 may initialize one or more registers and one or more interrupt tables to cause sampling of the instructions being performed by the processor 250. For example, the registers and interrupt tables in the processor 250 may be programmed to register an interrupt handler and cause the interrupt handler to be periodically called (e.g., programming them with an address to the interrupt handler). Such programming of the interrupt tables may be done by going through the OS to get pointers to them, and may be done so as not to interfere with any other interrupts (e.g., by registering toward the end of an interrupt table, and/or by first checking an interrupt table location to be used, so as not to erase another programmed interrupt).

The driver 230 may set up the interrupt handler, which is periodically called. The interrupt handler may check an instruction pointer, or a specified location, to find an instruction to be retired, and store information corresponding to that instruction in the shared memory 240. For example, the interrupt handler may read the reorder buffer 280 and place an opcode for a current instruction to be retired into the shared memory 240.

Regardless of the design configuration, the monitor 210 may provide real-time display of instruction mix in the processor 250 without significantly affecting system performance. The instructions being performed by the processor are only sampled, meaning not all instructions are trapped. The sampling of instructions may be controlled using sampling-interval and sampling-rate information.

For example, the driver may cause an instruction trap every X number of instructions, where the instruction trap results in the instruction opcode being stored in the shared memory 240, and the monitor 210 may analyze the shared memory 240 periodically based on a specified sampling interval. An instruction sampling pool size may correspond generally to the number of instructions trapped during a sampling interval, but not precisely, as instruction lengths are variant, and bandwidth and latency varies with instruction type. In general, the instruction throughput is based on an average of instruction types and the machine architecture itself.

At initialization, the monitor 210 may direct the driver 230 to sample such that less than an eight of all instructions are trapped at any given time. The sampling interval and the sampling rate may then be changed as needed to adjust the sampling. But in general, the monitor maintains a low impact on the computing system, and the number of instructions trapped remains less than a fourth, and often less than a sixteenth of all instructions at any given time.

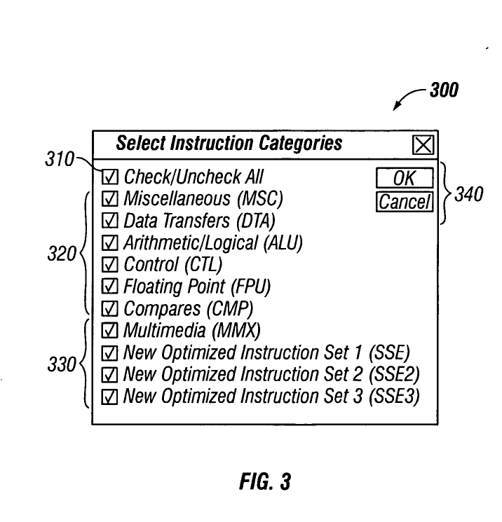

FIG. 3 illustrates an example user interface 300 for selecting instruction categories to monitor. The interface 300 may use check-box interface elements, such as a check-box 310, which may be used to check or uncheck all the available instruction types with a single input action. The interface 300 may allow individual selection of multiple legacy instruction types 320 and also multiple new optimized instruction types 330. The interface 300 may also include OK and Cancel button interface elements 340.

The legacy instruction types 320 available to be monitored may include miscellaneous instructions (MSC), data transfer instructions (DTA), arithmetic-logical instructions (ALU), control instructions (CTL), floating point instructions (FPU), and compare instructions (CMP). The optimized instruction types 330 available to be monitored may include multimedia instructions (MMX), and one or more new optimized instruction sets, such as new optimized instruction sets 1, 2, and 3 (SSE, SSE2, SSE3).

FIG. 4 illustrates an example display of an instruction mix property sheet 410 in a presentation window 400 of an instruction mix monitor. The instruction mix property sheet 410 presents a display area 430 showing a representation of real-time instruction mix utilization, including an indication of a percent of the machine instructions that are optimized for the processor. The display area 430 shows an animated graphic in the form of progress control bars for each of the selected instruction types. These progress control bars indicate the percentage of instructions, such as the percentage per sample, that fall into the respective instruction categories. The control bars rise and fall in real time, showing instruction mixes in real time.

FIG. 5 illustrates the display of the instruction mix property sheet in the presentation window 400 at a later time. As shown, the progress control bars in the display area 430 have now risen on the optimized instructions side. The larger instruction categories of legacy instructions and optimized instructions provide a clear indication of whether a software application is using the more advanced features of a processor. If the progress control bars fail to rise, or rarely rise, on the optimized instruction side of the display area 430, this indicates that the software may not be as efficient as it could be.

This quickly raises awareness regarding how the software is being executed in the computing system and whether an application is taking full advantage of the processor. The instruction mix monitor can provide a quick and easy view into instruction mix performance for software engineers and end users. The presented information may be useful generally for end users to distinguish among various software products, and this information may also be used to assist in improving software during its development.

The animated graphic in the display area 430 changes with processor usage, and reveals the new architectural features of the processor using the labels for the control bars (e.g., MMX, SSE, SSE2, SSE3; these labels have been selected for illustration only, and may be replaced with labels corresponding to the optimized instruction sets available in a particular processor architecture). Moreover, the animated graphic or the entire window 400 may be presented over a network (e.g., in web page) for remote viewing and interaction.

The instruction mix property sheet may also show processor utilization in a display area 440, including showing hyper-threading utilization (physical/logical processor utilization). Hyper-threading is a technology where there is one physical processor, but multiple logical processors. The instruction monitor may show each processor thread being utilized as described above and as shown in FIG. 5: two logical processors L0, L1 are represented with two processor utilization bars having a color gradient indicating usage.

In addition, the instruction mix monitor may show the current actual processor speed, as described above, in a processor frequency display area 420. This display area 420 may show the processor frequency rating in GHz (e.g., 3.200), the current processor frequency (e.g., 3.049), and a bar graphic indicating both. Moreover, the window 400 may include a help button 450 used to obtain information about, and/or configure, the instruction mix monitor. For example, the help button 450 may pull up the example user interface 300 illustrated in FIG. 3.

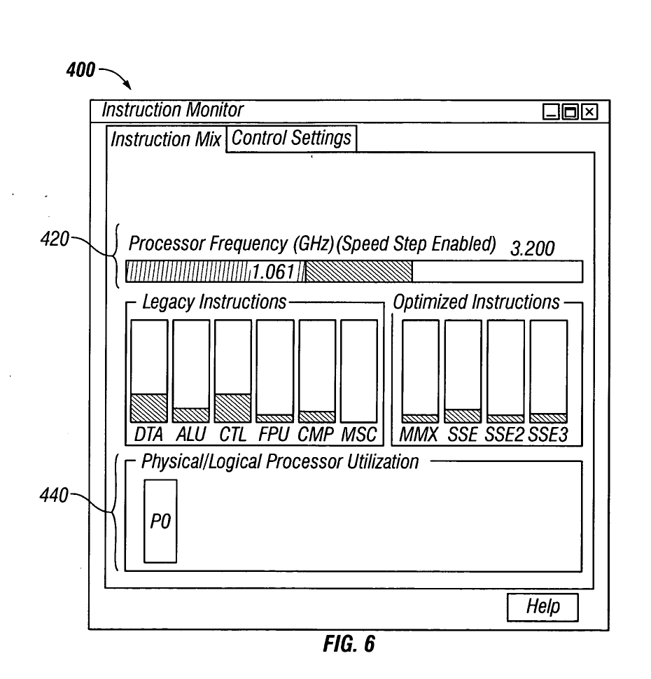

FIG. 6 illustrates the display of the instruction mix property sheet of FIG. 4 with speed-step monitoring enabled. The display area 420 now includes “(SpeedStep Enabled)” to indicate that the data processing system is using speed stepping. The instruction mix monitor may detect speed stepping and adjust the frequency display when speed stepping is enabled. The display area 420 shows a bifurcated frequency bar, with current processor frequency shown in green and the additional available processor frequency shown in red, in addition to showing the current frequency (e.g., 1.061). Additionally, only one physical processor, P0, is shown in the physical/logical processor utilization display area 440.

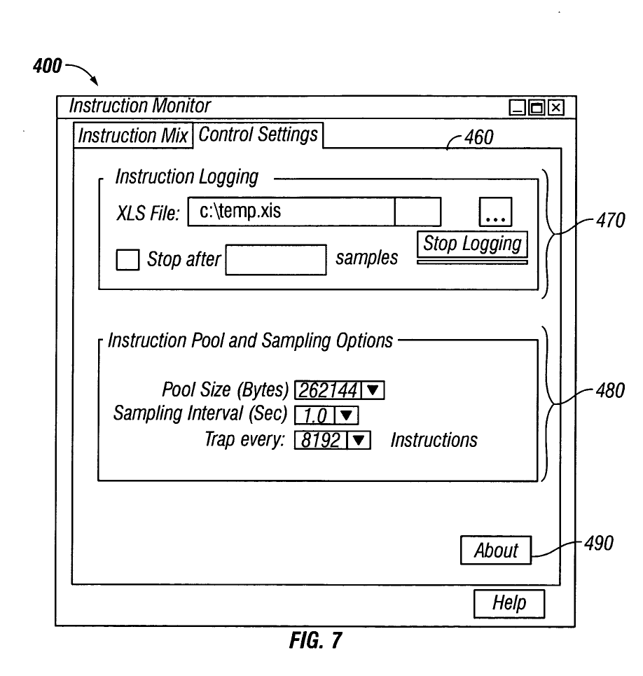

FIG. 7 illustrates an example display of a control settings property sheet 460 in the presentation window 400 of an instruction mix monitor. The control settings property sheet 460 may include an instruction logging control interface 470. The control interface 470 may include an input box for specifying an output log file (e.g., an XLS file, such as c:\temp.xls), a browse button for browsing for an output file, a stop logging button, and a “stop after” check-box interface with a input box for specifying the number of samples after which to stop logging.

The control settings property sheet 460 may include an instruction pool and sampling options control interface 480. The control interface 480 may include a first input interface to specify the pool size in bytes (e.g., with a default of 262,144 bytes), a second input interface to specify the sampling interval in seconds (e.g., with a default of 1.0 sec), and a third input interface to specify a number of instructions to be retired between each instruction trap (e.g., with a default of trap every 8192 instructions). The control interface 480 may also include an “about” button 490 to obtain additional information regarding how to use the control interface.

The logic flow depicted in FIG. 1 does not require the particular order shown or that all operations illustrated be performed. Other embodiments may be within the scope of the following claims.

1. A machine-implemented method comprising:
sampling machine instructions being performed by a processor;
identifying instruction types of the sampled machine instructions; and
presenting a metric indicating utilization of the processor by identified instruction types.

2. The method of claim 1, wherein sampling the machine instructions comprises:
identifying machine instructions to be retired from the processor; and
storing information corresponding to the machine instructions to a shared memory region.

3. The method of claim 2, wherein identifying machine instructions to be retired from the processor comprises reading a reorder buffer in the processor.

4. The method of claim 2, wherein the shared memory region comprises physical memory, and identifying the instruction types comprises decoding the information stored in the shared memory region.

5. The method of claim 2, wherein presenting the metric comprises displaying a representation of real-time instruction mix utilization including an indication of a percent of the machine instructions that are optimized for the processor.

6. The method of claim 2, wherein sampling the machine instructions occurs in kernel-mode, identifying the instruction types occurs in user-mode, and presenting the metric occurs in user-mode.

7. The method of claim 1, further comprising selecting the instruction types to be identified from a set of available instruction categories based on received input.

8. The method of claim 1, further comprising logging to an output file the utilization of the processor by identified instruction types.

9. The method of claim 1, further comprising:
presenting a user interface capable of receiving adjustments to a sampling interval and a sampling rate; and
adjusting the sampling of machine instructions based on input received via the user interface.

10. The method of claim 1, further comprising displaying actual processor speed in real time as the speed varies.

11. An article comprising a machine-readable medium embodying information indicative of instructions that when performed by one or more machines result in operations comprising:
identifying instruction types of sampled machine instructions being performed by a processor; and
presenting a metric indicating utilization of the processor by identified instruction types.

12. The article of claim 11, wherein the machine instructions comprise instructions to be retired from the processor, and identifying the instruction types comprises decoding stored information corresponding to the machine instructions to be retired.

13. The article of claim 11, wherein presenting the metric comprises displaying a representation of real-time instruction mix utilization including an indication of a percent of the machine instructions that are optimized for the processor.

14. The article of claim 11, wherein the operations further comprise selecting the instruction types to be identified from a set of available instruction categories based on received input.

15. The article of claim 11, wherein the operations further comprise logging to an output file the utilization of the processor by identified instruction types.

16. The article of claim 11, wherein the operations further comprise:
presenting a user interface capable of receiving adjustments to a sampling interval and a sampling rate; and
adjusting the sampling of machine instructions based on input received via the user interface.

17. The article of claim 11, wherein the operations further comprise displaying actual processor speed in real time as the speed varies.

18. A system comprising:
a shared memory that receives information corresponding to a subset of machine instructions retired from a processor; and
an instruction mix monitor that identifies instruction types based on the information in the shared memory and presents a metric indicating utilization of the processor by identified instruction types.

19. The system of claim 18, wherein the shared memory comprises physical memory.

20. The system of claim 18, wherein the instruction mix monitor comprises a display presentation that shows a representation of real-time instruction mix utilization, including an indication of a percent of the machine instructions that are optimized for the processor.

21. The system of claim 20, wherein the instruction mix monitor further comprises an instruction categories selection interface.

22. The system of claim 20, wherein the instruction mix monitor further comprises an instruction logging control interface.

23. The system of claim 20, wherein the instruction mix monitor further comprises a sampling adjustment control interface.

24. The system of claim 20, wherein the instruction mix monitor further comprises a display presentation that shows actual processor speed in real time as the speed varies.

25. A system comprising:
means for monitoring instruction mix in a processor; and
means for displaying in real time the monitored instruction mix in the processor.

26. The system of claim 25, further comprising means for displaying processor frequency in real time.
